(19) United States
(12) Patent Application Publication
(10) Pub. No.: US 2005/0075029 A1
(43) Pub. Date: Apr. 7, 2005

(54) Waterproof cover and process for manufacturing the same

(75) Inventors: Yasumichi Ogawa, Kurashiki-shi (JP); Hiroshi Nobuhara, Kurashiki-shi (JP); Yasunari Noritake, Kurashiki-shi (JP); Yohei Kogai, Maniwa-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Marugo Rubber Industries, Ltd., Kurashiki-shi (JP)

(21) Appl. No.: 10/879,469

(22) Filed: Jun. 30, 2004

(30) Foreign Application Priority Data
Oct. 2, 2003 (JP) 2003-344158
Apr. 7, 2004 (JP) 2004-113263

(51) Int. Cl. D04H 13/00; D04H 3/00; B32B 5/26; B32B 5/22; D04H 5/00

(52) U.S. Cl. 442/327; 442/381; 442/393; 442/400; 442/415; 442/417

(57) ABSTRACT

A waterproof cover to be interposed between an inner panel and a door trim of an automobile door is obtained by forming a sheet of a resin composition comprising a linear low-density polyethylene (A) and an ethylene-propylene copolymer (B). Further, a waterproof cover to be interposed between an inner panel and a door trim of an automobile door is obtained by bonding a melt-blown nonwoven fabric made of a polyolefin fiber to an inner surface of a sheet being made mainly of a polyolefin. In manufacturing the waterproof cover, it is preferable that the sheet made mainly of the polyolefin is thermoformed by drape-forming to obtain convex portions. The waterproof cover can suppress occurrence of a vibration sound and is excellent in sound absorption and recycling property.

### BACKGROUND OF THE INVENTION

1. Field of the Invention

The present invention relates to a waterproof cover which is interposed between an inner panel and a door trim of an automobile door to prevent water from invading the inside of the automobile.

2. Description of Related Art

In order to prevent water from invading the inside of the automobile through the automobile door, a waterproof cover is mounted between an inner panel and a door trim of the automobile door. Many parts such as a speaker, a window glass lifting mechanism and a door lock mechanism and wirings for controlling these parts are intricately inserted in the automobile door. Further, a cushioning material for protecting passengers from a lateral shock is often inserted therein. Accordingly, for inserting these parts, the cushioning material and the like, the waterproof cover is required, in many cases, to have a three-dimensional shape.

As a method for forming a three-dimensional waterproof cover, thermoforming is widely employed because it can easily be performed. The thermoforming is a method for forming a preheated sheet according to a mold. As a material of the waterproof cover, polyvinyl chloride (PVC) has been widely used so far. Polyvinylchloride is a resin excellent in flexibility, good in thermoformability and also excellent in durability. Thus, it is a preferable resin as the material of the waterproof cover. For example, JP-A-2001-287546 describes an example of a waterproof cover using polyvinyl chloride.

However, since polyvinyl chloride might generate an acid gas or dioxins in burning, its use has been gradually avoided in recent years due to environmental consideration. It has been further required lately to recycle a resinous material used in automobiles. In view of a recycling property, a polyolefin resin is excellent, and it has been increasingly used.

For example, JP-A-10-6771 describes an example of a waterproof cover (sealing screen) which is obtained by vacuum-forming a low-density polyethylene sheet and packing a polypropylene foam into its deep-formed portion. However, the low-density polyethylene sheet has insufficient flexibility. The sheet was therefore problematic in that when a speaker was installed on the sheet, the sheet was vibrated to generate a noise. Further, a vibration sound was sometimes generated by air during driving. Still further, formability of the deep-formed portion was not altogether satisfactory either, and it was not necessarily easy to efficiently produce a formed product excellent in strength.

JP-A-8-72623 describes a method in which a vibration insulator is interposed between a waterproof cover and a speaker to prevent resonance due to vibration of the speaker and stop a noise. In this case, however, a vibration-absorbing property of the waterproof cover itself was not improved, and its vibration-proof effect was not altogether said to be satisfactory.

JP-A-8-58378 (U.S. Pat. No. 5,560,967) describes, as a waterproof sheet (water deflector sheet) excellent in sound absorption, a waterproof sheet made of a composite sheet in which a urethane foam is held between inner and outer layers comprising an octene-type linear low-density polyethylene. Such a structure is considered to improve the sound absorption and suppress occurrence of the vibration sound. However, the production cost of the sheet itself is increased, and polyethylene and polyurethane are used in combination to much decrease the recycling property. It is further difficult to provide a three-dimensional shape.

### SUMMARY OF THE INVENTION

The invention has been made to solve the foregoing problems, and it aims to provide a waterproof cover which is interposed between an inner panel and a door trim of an automobile door, and which can suppress occurrence of a vibration sound and is excellent in sound absorption and also in recycling property. Further, it aims to provide a process for manufacturing the waterproof cover, in which a three-dimensional shape can be provided with good productivity.

It is an object of the invention to provide a waterproof cover to be interposed between an inner panel and a door trim of an automobile door, the waterproof cover being made of a resin composition comprising a linear low-density polyethylene (A) and an ethylene-propylene copolymer (B). At this time, it is preferable that an amount of the linear low-density polyethylene (A) is from 50 to 98 parts by weight and an amount of the ethylene-propylene copolymer (B) is from 2 to 50 parts by weight, per 100 parts by weight in total of the linear low-density polyethylene (A) and the ethylene-propylene copolymer (B). It is also preferable that the resin composition further comprises an inorganic filler (C) in an amount of from 0.1 to 10 parts by weight per 100 parts by weight in total of the linear low-density polyethylene (A) and the ethylene-propylene copolymer (B), and that the resin composition further comprises a lubricant (D), especially a fatty acid amide, in an amount of from 0.01 to 2 parts by weight per 100 parts by weight in total of the linear low-density polyethylene (A) and the ethylene-propylene copolymer (B). It is a preferable embodiment that the waterproof cover is made of a sheet having a convex portion. At this time, it is preferable that a thickness of the sheet is from 0.05 to 0.5 mm, and that a height of the convex portion is 20 mm or more. It is also a preferable embodiment that the waterproof cover is obtained by thermoforming the sheet of the resin composition.

Another object of the invention is to provide a waterproof cover to be interposed between an inner panel and a door trim of an automobile door, in which a melt-blown nonwoven fabric made of a polyolefin fiber is bonded to an inner surface of a sheet being made mainly of a polyolefin. An inner surface herein means the surface facing the inside of the automobile. At this time, it is preferable that the melt-blown nonwoven fabric comprises a polyolefin fiber and a polyester fiber, and a thickness of the fabric as measured under a load of 1.37×10⁻³ N/cm² is from 3 to 30 mm.

Still another object of the invention is to provide a process for manufacturing a waterproof cover to be interposed between an inner panel and a door trim of an automobile door, which comprises forming a sheet of a resin composition comprising a linear low-density polyethylene (A) and an ethylene-propylene copolymer (B) to obtain a convex portion. A further object of the invention is to provide a process for manufacturing a waterproof cover to be interposed between an inner panel and a door trim of an automobile door, which comprises thermoforming a sheet made mainly of a polyolefin by drape-forming to obtain a convex portion. In these processes, it is preferable that after forming the sheet, a melt-blown nonwoven fabric made of a polyolefin fiber is laminated, and both of them are partially melt-bonded.

The waterproof cover of the invention can suppress occurrence of a vibration sound due to a speaker or the like and is excellent in sound absorption and also in recycling property. Further, according to the process for manufacturing the waterproof cover of the invention, a three-dimensional shape excellent in strength can be obtained with good productivity.

### BRIEF DESCRIPTION OF THE DRAWINGS

FIG. 1 is an exploded perspective view showing an outline of an automobile door including a waterproof cover of the invention; and

FIG. 2 is a perspective view of a waterproof cover manufactured in EXAMPLES 1 to 4.

In the drawings, 1 is a waterproof cover, 2 an automobile door, 3 an outer panel, 4 an inner panel, 5 a door body, 6 a door trim, 7 a speaker, 8 a speaker insertion hole, 9 an opening portion, 10, 11 convex portions, 12, 13 cushioning materials, 14 a nonwoven fabric, and 15 a bonding portion.

### DESCRIPTION OF THE PREFERRED EMBODIMENTS

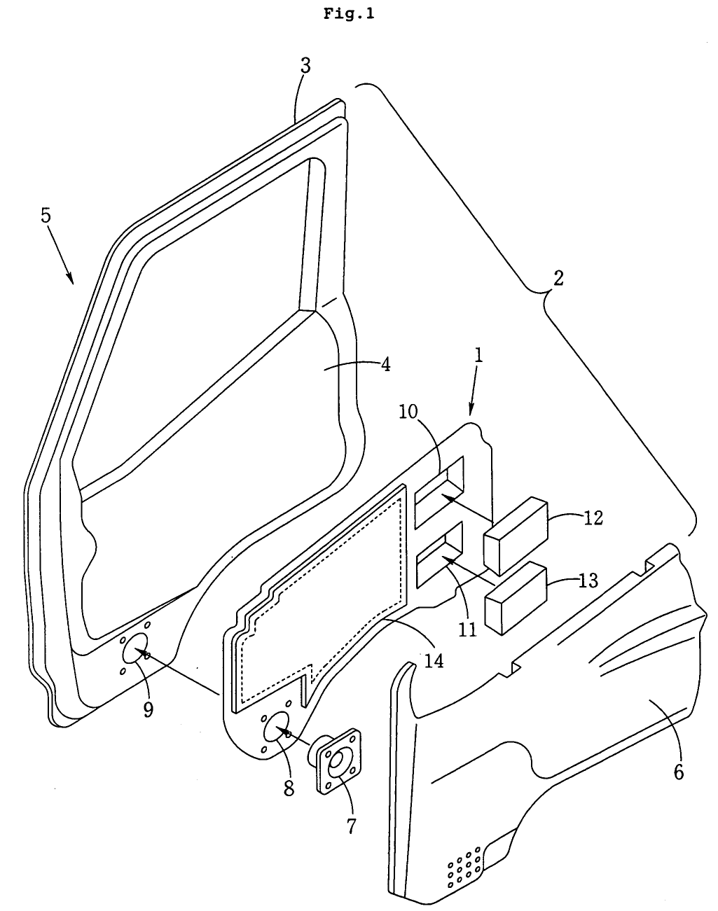

FIG. 1 is an exploded perspective view showing an outline of an automobile door 2 including a waterproof cover 1 of the invention. The use embodiment of the waterproof cover 1 of the invention is briefly described by referring to this drawing. The automobile door 2 is constructed of a door body 5 comprising an outer panel 3 and an inner panel 4 made of a steel plate, and a decorative door trim 6. The door trim 6 is mounted on a side surface of the inner panel 4 in the position lower than a window opening. The waterproof cover 1 is interposed between the inner panel 4 and the door trim 6 to prevent water from invading the inside of the automobile. Parts such as a window regulator for lifting a window glass and a speaker 7 are contained in a space between the outer panel 3 and the inner panel 4. Waterproofing is applied to prevent invasion of water from outside.

A speaker penetration hole 8 is bored in the waterproof cover 1. The speaker 7 is inserted into the speaker penetration hole 8, and these are adhered so as not to leak water between the speaker 7 and the waterproof cover 1. The speaker 7 is installed in an opening portion 9 provided in the inner panel 4, and a waterproof means is provided to be able to prevent water from invading the speaker 7. Convex portions 10, 11 are formed on the waterproof cover 1, and cushioning materials 12, 13 for absorbing a lateral shock are inserted into the convex portions 10, 11. A nonwoven fabric 14 is bonded, as required, to the inner surface of the waterproof cover 1. Further, small holes through which to penetrate wirings and the like are bored as required.

The waterproof cover of the invention is characterized in that it is made of a resin composition comprising a linear low-density polyethylene (A) and an ethylene-propylene copolymer (B). This structure can provide a flexible waterproof cover in which a noise due to vibration of the speaker or a vibration sound due to wind during driving less occurs. Since both of the linear low-density polyethylene (A) and the ethylene-propylene copolymer (B) are polyolefin resins, they can easily be recovered and reused, and generation of poisonous gases in burning can be suppressed. Further, a formed product excellent in formability, especially thermoformability and strength can be obtained.

The linear low-density polyethylene (LLDPE) (A) used in the invention is a low-density polyethylene having a linear structure substantially free of a long-chain branch, and it is obtained by randomly copolymerizing ethylene with an α-olefin. Since a high-density polyethylene is poor in flexibility and a low-density polyethylene having a long-chain branch is decreased in formability and strength, the linear low-density polyethylene (A) is employed. The use of an ethylene-vinyl acetate copolymer obtained by copolymerizing vinyl acetate instead of the α-olefin is undesirable because the cost of the material is increased and an acetic acid smell might be generated in thermoforming.

With respect to the α-olefin which is copolymerized in the linear low-density polyethylene (A), an α-olefin having from 3 to 8 carbon atoms is preferable. Examples of the α-olefin having from 3 to 8 carbon atoms include propylene, 1-butene, isobutene, 1-pentene, 1-hexene, 1-heptene, 1-octene, 3-methyl-1-butene, 4-methyl-1-pentene and 4,4-dimethyl-1-pentene. These α-olefins may be used either singly or in combination. Of these, 1-butene, isobutene, 1-pentene, 1-hexene, 4-methyl-1-pentene and 1-octene are more preferable because the cost of the monomer is low and the copolymer composition can widely be controlled.

The density of the linear low-density polyethylene (A) usually exceeds 0.90 g/cm³ and at most 0.94 g/cm³. When the density is 0.90 g/cm³ or less, there is a likelihood that the strength is decreased and the shape retention is also decreased. It is preferably 0.91 g/cm³ or more, more preferably 0.915 g/cm³ or more. Meanwhile, when the density exceeds 0.94 g/cm³, there is a likelihood that the flexibility is decreased and the effect of suppressing a vibration sound is decreased. It is further preferably 0.93 g/cm³ or less.

The ethylene-propylene copolymer (B) used in the invention is an elastomer obtained by copolymerizing ethylene with propylene. The ethylene-propylene copolymer (B) is an olefin polymer, and has good compatibility with the linear low-density polyethylene (A) which is also an olefin polymer. For this reason, both of them can be blended relatively easily, and are suitable for recycling. Further, the durability thereof is excellent in comparison to a diene elastomer.

In the ethylene-propylene copolymer (B), it is preferable that the amount of ethylene is from 40 to 85% by weight and the amount of propylene is from 15 to 60% by weight. It is more preferable that the amount of ethylene is from 45 to 75% by weight and the amount of propylene is from 25 to 55% by weight. The density is usually at least 0.85 g/cm³ and at most 0.90 g/cm³. When the density is less than 0.85 g/cm³, crystallinity of the resin is quite low, and it is difficult to handle the ethylene-propylene copolymer (B) itself. There is a likelihood that slipperiness between sheets subjected to forming is worsened to make the forming difficult. It is more preferably at least 0.86 g/cm³. Meanwhile, when the density exceeds 0.90 g/cm³, the effect of imparting the flexibility or the vibration absorption to the waterproof cover might be insufficient. It is further preferably at most 0.89 g/cm³.

The ethylene-propylene copolymer (B) may contain another copolymerizable component in a small amount. For example, as the ethylene-propylene copolymer (B), an ethylene-propylene-diene copolymer (EPDM) can be used. At this time, the amount of the diene component is usually 10% by weight or less, preferably 5% by weight or less, more preferably 2% by weight or less. Since EPDM containing a small amount of the diene component can be produced at low cost as a commodity elastomer material, it can be used similarly to the copolymer comprising ethylene and propylene alone. In case of using EPDM, a crosslinking agent may be used in kneading with the linear low-density polyethylene (A) to crosslink EPDM particles in the resin composition. However, in view of the production cost, the crosslinking is usually unnecessary.

In the resin composition constituting the waterproof cover, it is preferable that the amount of the linear low-density polyethylene (A) is from 50 to 98 parts by weight and the amount of the ethylene-propylene copolymer (B) is from 2 to 50 parts by weight, per 100 parts by weight in total of the linear low-density polyethylene (A) and the ethylene-propylene copolymer (B). When the amount of the ethylene-propylene copolymer (B) is less than 2 parts by weight, the effect of improving the flexibility of the waterproof cover tends to be unsatisfactory. It is more preferably 5 parts by weight or more, further preferably 10 parts by weight or more. Meanwhile, when the amount of the ethylene-propylene copolymer (B) exceeds 50 parts by weight, the strength of the waterproof cover tends to be unsatisfactory, and the forming tends to be difficult. It is further preferably 30 parts by weight or less.

It is preferable that the resin composition constituting the waterproof cover further comprises the inorganic filler (C). The inorganic filler (C) can improve the slipperiness between sheets to prevent blocking when sheets are stored in piles. Especially, since the sheet used in the invention contains the ethylene-propylene copolymer (B), blocking is liable to occur in comparison to the sheet made only of the linear low-density polyethylene (A). Thus, it is highly required to incorporate the inorganic filler (C). The improvement of the slipperiness contributes to the better stretchability and releasability in forming. In case of employing thermoforming, especially drape-forming, the releasability tends to be decreased in comparison to straight-forming. Thus, it is highly required to incorporate the inorganic filler (C). As the inorganic filler (C), talc, clay, kaolin, calcium carbonate, silica, alumina, magnesium hydroxide, magnesium oxide and the like can be used.

The amount of the inorganic filler (C) in the resin composition is preferably from 0.1 to 10 parts by weight per 100 parts by weight in total of the linear low-density polyethylene (A) and the ethylene-propylene copolymer (B). When the amount of the inorganic filler (C) is less than 0.1 part by weight, the effect of improving the slipperiness might be insufficient. It is more preferably 0.3 part by weight or more. Meanwhile, when the amount of the inorganic filler (C) exceeds 10 parts by weight, the strength of the sheet might be decreased, and the formability might also be decreased. It is further preferably 5 parts by weight or less.

It is also preferable that the resin composition constituting the sheet further comprises the lubricant (D). The lubricant (D) is incorporated, like the inorganic filler (C), to prevent blocking and improve the slipperiness. The lubricant (D) can improve the slipperiness of the sheet in a small amount in comparison to the inorganic filler (C). However, the long-term use might decrease the effect of improving the slipperiness by bleeding the lubricant (D). Accordingly, in view of the stable effect of improving the slipperiness for a long period of time, the inorganic filler (C) is superior to the lubricant (D). For this reason, it is especially preferable to incorporate the lubricant (D) along with the inorganic filler (C). As the lubricant (D), it is advisable to use an organic compound which is added to improve the slipperiness of the surface of the formed product. The material is not particularly limited. Examples thereof include aliphatic hydrocarbons (paraffins), higher fatty alcohols, higher fatty acids, fatty acid salts (metallic soaps), fatty acid esters, fatty acid amides and the like. The carbon number in these compounds is usually from 10 to 50. Of these, fatty acid salts, fatty acid esters and fatty acid amides are preferably used, and fatty acid amides are especially preferable. Erucic acid amide, oleic acid amide, stearic acid amide, behenic acid amide, ethylene-bis-stearic acid amide, ethylene-bis-oleic acid amide and the like are listed as preferable compounds.

The amount of the lubricant (D) in the resin composition is preferably from 0.01 to 2 parts by weight per 100 parts by weight in total of the linear low-density polyethylene (A) and the ethylene-propylene copolymer (B). When the amount of the lubricant (D) is less than 0.01 part by weight, the effect of improving the slipperiness might be insufficient. It is more preferably 0.02 part by weight or more. Meanwhile, when the lubricant (D) exceeds 2 parts by weight, the lubricant might be bled. It is more preferably 1 part by weight or less.

The linear low-density polyethylene (A), the ethylene-propylene copolymer (B), the inorganic filler (C) and the lubricant (D) are melt-kneaded, and then formed into a sheet. The resin composition obtained by previously melt-kneading the starting materials with an extruder or the like may be fed to a forming machine. It is also possible that the starting materials are charged into a kneading section of a forming machine where they are melt-kneaded and the mixture is directly formed. The forming machine is not particularly limited. The mixture may be extruded from a T die, or it may be subjected to inflation-forming. The thickness of the sheet varies with required properties. In consideration of the balance of the strength and the weight, it is usually preferable that the thickness is from 0.05 to 0.5 mm.

The sheet is cut according to the size of the door or the like. The cutting size is, in case of an automobile door, usually from 500 to 600 mm in length, and from 600 to 800 mm in width. Further, it is preferable to bore the speaker insertion hole simultaneously with the cutting. The size of the speaker insertion hole is usually from 100 to 200 mm in diameter. Other small holes for penetration of wirings can also be bored simultaneously.

The thus-cut sheet is formed into the waterproof cover. The preferable process for manufacturing the waterproof cover of the invention comprises forming the sheet of the resin composition comprising the linear low-density polyethylene (A) and the ethylene-propylene copolymer (B) to obtain the convex portion. The forming method is not particularly limited, and thermoforming and cold-forming are both available. In view of the good formability, thermoforming is preferable. However, in view of the productivity, cold-forming is, in some cases, preferable. Examples of the cold-forming include cold-drawing and pressing. The thermoforming here referred to means that the sheet or film once melt-formed is softened by preheating and then formed in vacuo or with air pressure according to a mold. In the thermoforming, vacuum-forming and air pressure-forming are both available. Vacuum-forming is preferable. In the vacuum-forming, straight-forming using a female mold and drape-forming using a male mold can both be employed. In the invention, it is preferable to employ drape-forming. The straight-forming here referred to is a method in which vacuum holes are bored in a female mold (concave mold) and the preheated sheet is contacted to the inner wall of the female mold by being drawn from the vacuum holes. This method has a feature that the thickness of the formed portion is decreased. For improving this point, plug assist-forming in combination with an operation of mechanical forcing with a plug is performed to improve the formability, but the problem of decreasing the thickness of the formed portion still remains. On the other hand, the drape-forming is a method in which vacuum holes are bored in a male mold (convex mold), the preheated sheet is contacted to the outer surface of the male mold by being drawn from the vacuum holes and the mold is forced to form the sheet. In this method, the decrease in thickness of the formed portion can be suppressed, but the thickness of the flat portion around the formed portion is slightly decreased.

When the thermoformed product is used as the waterproof cover, it is considered that because of the presence of the extremely thin portion, a possibility of leaking water is increased and a vibration sound tends to be generated. Accordingly, it is preferable to increase the thickness of the formed portion even though the thickness of the flat portion is slightly changed. Especially, the bottom of the shaped portion is, in many cases, protruded toward the outside of the door, and there is a high possibility that parts, wirings and the like installed inside the door are brought into contact with the edge of the formed portion. In view of the waterproofing property, it is most important to increase the thickness of this portion. Accordingly, it is preferable that thermoforming is performed by drape-forming in the waterproof cover of the invention.

In both the straight-forming and the drape-forming, the sheet is preheated, then stretched, formed and cooled to obtain a formed product. However, in the drape-forming, the good formed product can be obtained even though the preheating time, the forming time and the cooling time are shortened. Accordingly, in view of improving the productivity by shortening the cycle time of the forming, the drape-forming has been found to be preferable.

To manufacture the waterproof cover by conducting the thermoforming through the drape-forming to obtain the convex portion is useful not only in thermoforming the sheet of the resin composition comprising the linear low-density polyethylene (A) and the ethylene-propylene copolymer (B) but also in thermoforming the sheet made mainly of the polyolefin. That is, the problems of the invention are solved by providing a process for manufacturing a waterproof cover to be interposed between an inner panel and a door trim of an automobile door, which comprises thermoforming a sheet made mainly of a polyolefin by drape-forming to obtain a convex portion. At this time, the sheet made mainly of the polyolefin is preferably a sheet made mainly of polyethylene, more preferably a sheet made mainly of a low-density polyethylene, further preferably a sheet made mainly of a linear low-density polyethylene (A), especially preferably a sheet of a resin composition comprising a linear low-density polyethylene (A) and an ethylene-propylene copolymer (B).

The height of the thus-obtained convex portion is preferably 20 mm or more. When the deep-forming is thus performed, it is quite advantageous to employ the resin composition comprising the linear low-density polyethylene (A) and the ethylene-propylene copolymer (B) and the manufacturing process of the invention. The height of the convex portion is more preferably 30 mm or more. Meanwhile, the height of the convex portion is usually 100 mm or less, preferably 60 mm or less. The length and the width of the convex portion vary with the type of the automobile, and are usually from 50 to 200 mm. A material which is packed in such a convex portion is not particularly limited. Preferably, a cushioning material is packed therein to protect passengers from a lateral shock. Plural convex portions may be employed. It is preferable that two or more convex portions are formed and a cushioning material is packed in each of them. The convex portion is preferably protruded to the outside of the automobile in many cases, but it may be protruded to the inside of the automobile.

In the sheet which is thus formed as required, it is advisable that a sound absorbing material is bonded to the inner surface of the sheet for improving the soundproofing and the sound absorption. The type of the sound absorbing material is not particularly limited, and a nonwoven fabric or a resin foam can be used. At this time, it is preferable that the surface in contact with the sheet is made of a polyolefin because it can be melt-bonded by heating. It is especially preferable that a melt-blown nonwoven fabric made of a polyolefin fiber is bonded thereto. The bonding of the melt-blown nonwoven fabric made of the polyolefin fiber is useful not only in case of the waterproof sheet made of the resin composition comprising the linear low-density polyethylene (A) and the ethylene-propylene copolymer (B) but also in case of the waterproof sheet made mainly of the polyolefin. That is, the problems of the invention are solved by providing a waterproof cover to be interposed between an inner panel and a door trim of an automobile door, in which a melt-blown nonwoven fabric made of a polyolefin fiber is bonded to an inner surface of a sheet being made mainly of a polyolefin.

The melt-blown nonwoven fabric is excellent in sound absorption because the fiber diameter is quite small. Moreover, since the nonwoven fabric made of the polyolefin fiber is used, it can easily be recycled along with the sheet. At this time, the fabric may contain a fiber made of a thermoplastic resin other than the polyolefin. When the fabric contains the fiber made of the other thermoplastic resin, it is preferable that the amount of the polyolefin fiber is from 50 to 90 parts by weight and the amount of the fiber made of the other thermoplastic resin is from 10 to 50 parts by weight. Examples of the fiber made of the other thermoplastic resin include a polyester fiber and a polyamide fiber. It is preferable to incorporate the polyester fiber because the elastic modulus is high and the bulkiness of the nonwoven fabric can be maintained. It is preferable that the thickness of the nonwoven fabric as measured under a load of 1.37×10⁻³ N/cm² is from 3 to 30 mm. For improving the sound absorption, it is more preferable that the thickness is 8 mm or more. In consideration of the weight of the automobile and the size of the space inside the door, it is further preferable that the thickness is 20 mm or less.

Such a nonwoven fabric is bonded to the inner surface of the sheet after thermoforming. The bonding method is not particularly limited, and the bonding may be conducted using an adhesive. However, thermal melt-bonding is preferably employed. Since the sheet and the nonwoven fabric are both made of the polyolefin, the thermal melt-bonding property is good. In the thermal melt-bonding, it is advisable that the sheet is partially melt-bonded. Specifically, it is preferable that the peripheral portion of the nonwoven fabric is melt-bonded linearly or in a dotted state. Especially preferable is a method in which the sheet is placed on heat sources arranged linearly or in a dotted state, the nonwoven fabric is further laminated thereon and they are gently pressed from above the nonwoven fabric. A method in which pressing is conducted with air is especially preferable. By this method, the nonwoven fabric can be bonded without impairing the bulkiness thereof. In view of the sound absorption, it is advisable that an area which the nonwoven fabric covers is 50% or more of the sheet area. However, the sheet is often bonded while adjusting the position to the inner panel. In order to be able to bond the sheet while confirming positions of various wirings or the like, it is preferable that a portion to which the nonwoven fabric is not bonded remains on the peripheral portion. Accordingly, the area which the nonwoven fabric covers is 90% or less of the sheet area.

The thus-obtained waterproof cover of the invention is interposed between the inner panel and the door trim of the automobile door by packing the cushioning material in the formed convex portion and bonding the speaker to the hole. Specifically, a preferable embodiment is that a double-sided adhesive tape made of a butyl rubber is bonded to the inner panel and the waterproof cover of the invention is pushed thereon to bond the surroundings of the waterproof cover with the adhesive tape. At this time, wirings and the like sometimes penetrate the waterproof cover. In this case, it is advisable that the penetration portions of the wirings are sealed to prevent invasion of water. After the waterproof cover is bonded to the inner panel, the door trim is installed.

### EXAMPLES

The invention is illustrated specifically below by referring to EXAMPLES.

### Example 1

As starting materials of a sheet, the following materials were used in the following amounts.
Linear low-density polyethylene (A):
   80 parts by weight
   “J-Lex LL AF22NB” manufactured by Nippon Polyolefin K.K. specific gravity 0.923, MFR 0.45 g/10 min (JIS K 6922-2)
Ethylene-propylene copolymer (B):
   20 parts by weight
   “Nordel 3745P” manufactured by Du Pont DowElastomer Japan K.K., ethylene (70% by weight)-propylene (29.5% by weight)-ethylidene norbornene (0.5% by weight) copolymer specific gravity 0.88
Talc-containing polyethylene master batch:
   3 parts by weight talc content 20% by weight
Lubricant (D): 0.1 part by weight
   “Alflow P-10” (erucic acid amide) manufactured by NOF Corporation.

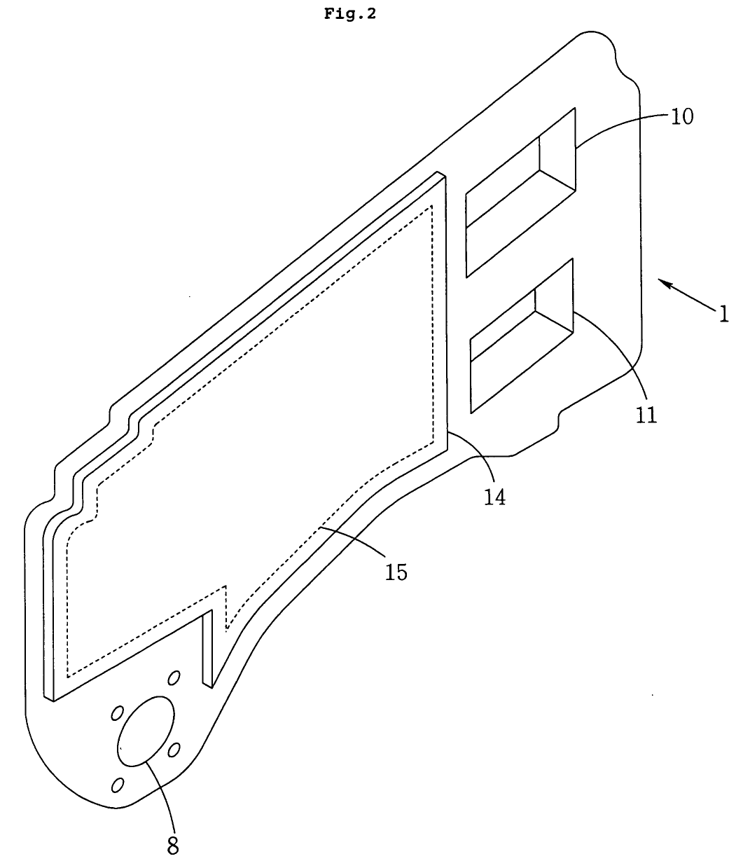

The starting materials were measured with an automatic meter, charged into an extruder fitted on an inflation-forming machine, extruded at a resin temperature of 210° C. with an extrusion rate of from 50 to 60 kg/hr, and subjected to inflation-forming to obtain a sheet having a thickness of 0.15 mm. The resulting sheet was cut out with a Thomson's blade according to an exterior shape of the waterproof cover 1 shown in FIG. 2, and then subjected to thermoforming. At this time, a circular speaker insertion hole 8 having a diameter of 150 mm was simultaneously cut out. Although the cut-out sheets were stored in piles, blocking did not occur between the sheets.

In the thermoforming, a vacuum-forming machine was used, and the forming was performed by drape-forming. Molds for drape-forming were male molds (convex shape), and vertically arranged on two positions corresponding to the rear portion of the door. The upper mold measured 90 mm in length, 150 mm in width and 45 mm in height, and a draft angle (inclination of a mold side surface) was approximately 7°. The lower mold measured 80 mm in length, 140 mm in width and 47 mm in height, and a draft angle was approximately 6°. A large number of small vacuum holes were bored in surfaces of both the molds such that air was exhausted toward the inside of the molds.

An area which was 120 mm long and 180 mm wide around a portion in contact with the upper mold and an area which was 110 mm long and 170 mm wide around a portion in contact with the lower mold were brought near a heater set at approximately 350° C., and heated for 13 seconds. Next, while air was exhausted from the vacuum holes in the surfaces of the molds, the molds were pressed against the sheet after the heating, and the sheet was formed by raising the molds over 1 second. After the forming, the sheet was cooled for 10 seconds, and then removed from the molds to obtain a thermoformed sheet.

In an upper convex portion 10 of the thus-thermoformed sheet, the thickness of the formed portion was measured. The thickness of the bottom of the convex portion 10 was from 0.11 to 0.14 mm. The thickness of the area near the boundary between the flat portion and the convex portion 10 of the sheet was from 0.10 to 0.12 mm. Since the bottom and the side were relatively thick in the formed portion, the strength of the formed portion was found to be excellent. When the heating time was reduced to 7 seconds, the softening of the sheet was insufficient to decrease the formability. The thickness of the formed product is shown in TABLE 1.

A nonwoven fabric 14 was bonded to the surface of the thermoformed sheet which was opposite to the surface on which the convex portions 10, 11 were formed. The nonwoven fabric 14 bonded here is a melt-blown nonwoven fabric “ThinsulateEmboss Type TAI-2047” manufactured by Sumitomo Three M K.K. This nonwoven fabric is a nonwoven fabric containing 65% by weight of polypropylene and 35% by weight of polyester and produced by a melt-blowing method, and the thickness thereof as measured under a load of 1.37×10⁻³ N/cm² is 10 mm. The nonwoven fabric 14 having a shape shown in FIG. 2 was prepared. The thermoformed sheet was placed on a hot plate in which hot wires were mounted on positions corresponding to the peripheral portion of the nonwoven fabric. Further, the nonwoven fabric 14 was placed thereon, and linearly bonded by being gently pressed from above with air pressure. The bonding portion 15 is shown by a broken line in FIG. 2, but bonding was actually conducted linearly. At this time, the nonwoven fabric could be bonded by pressing with air without impairing the bulkiness of the nonwoven fabric. This nonwoven fabric 14 covers an area of approximately 70% of the overall area of the sheet.

### Example 2

The same sheet (thickness 0.15 mm) as used in EXAMPLE 1 was subjected to the thermoforming. In the thermoforming, a vacuum-molding machine was used, and the forming was performed by straight-forming. Molds for straight-forming were female molds (concave shape), and vertically arranged on two positions corresponding to the rear portion of the door. The upper mold measured 90 mm in length, 150 mm in width and 45 mm in depth, and a draft angle was approximately 7°. The lower mold measured 80 mm in length, 140 mm in width and 47 mm in depth, and a draft angle was approximately 6°. A large number of small vacuum holes were bored in surfaces of both the molds such that air was exhausted toward the inside of the molds.

An area which was 120 mm long and 180 mm wide around a portion in contact with the upper mold and an area which was 110 mm long and 170 mm wide around a portion in contact with the lower mold were brought near a heater set at approximately 350° C., and heated for 18 seconds. Next, while air was exhausted from the vacuum holes in the surfaces of the molds, the sheet was formed by being contacted to the molds over 2 seconds. After the forming, the sheet was cooled for 13 seconds, and then removed from the molds to obtain a thermoformed sheet.

In an upper convex portion 10 of the thus-thermoformed sheet, the thickness of the formed portion was measured. The thickness of the bottom of the convex portion 10 was from 0.06 to 0.08 mm. The thickness of the area near the boundary between the flat portion and the convex portion 10 of the sheet was from 0.06 to 0.10 mm. Since the bottom and the side were relatively thin in the formed portion in comparison to EXAMPLE 1, the strength of the formed portion was found to be poor in comparison to EXAMPLE 1. When the heating time was reduced to 13 seconds, the softening of the sheet was insufficient to decrease the formability. The thickness of the formed product is shown in TABLE 1. The same nonwoven fabric 14 as used in EXAMPLE 1 was bonded to the surface of the thermoformed sheet which was opposite to the surface on which the convex portions were formed in the same manner as in EXAMPLE 1.

### Example 3

The sheet was produced as in EXAMPLE 1 except that the thickness of the sheet was changed to 0.07 mm, and the drape-forming was performed using the same vacuum-forming machine and molds as used in EXAMPLE 1. An area which was 120 mm long and 180 mm wide around a portion in contact with the upper mold and an area which was 110 mm long and 170 mm wide around a portion in contact with the lower mold were brought near aheater set at approximately 350° C., and heated for 8 seconds. Next, while air was exhausted from the vacuum holes in the surfaces of the molds, the molds were pressed against the sheet after the heating, and the sheet was formed by raising the molds over 1 second. After the forming, the sheet was cooled for 7 seconds, and then removed from the molds to obtain a thermoformed sheet.

In an upper convex portion 10 of the thus-thermoformed sheet, the thickness of the formed portion was measured. The thickness of the bottom of the convex portion 10 was from 0.05 to 0.06 mm. The thickness of the area near the boundary between the flat portion and the convex portion 10 of the sheet was from 0.03 to 0.05 mm. Since the bottom and the side were relatively thick in the formed portion, the strength of the formed portion was found to be excellent. When the heating time was reduced to 5 seconds, the softening of the sheet was insufficient to decrease the formability. The thickness of the formed product is shown in TABLE 1. The same nonwoven fabric 14 as used in EXAMPLE 1 was bonded to the surface of the thermoformed sheet which was opposite to the surface on which the convex portions were formed in the same manner as in EXAMPLE 1.

### Example 4

The same sheet (thickness 0.07 mm) as used in EXAMPLE 3 was subjected to the thermoforming. In the thermoforming, straight-forming was performed using the same vacuum-forming machine and molds as used in EXAMPLE 2. An area which was 120 mm long and 180 mm wide around a portion in contact with the upper mold and an area which was 110 mm long and 170 mm wide around a portion in contact with the lower mold were brought near a heater set at approximately 350° C., and heated for 10 seconds. Next, while air was exhausted from the vacuum holes in the surface of the molds, the sheet was formed by being contacted to the molds over 2 seconds. After the forming, the sheet was cooled for 7 seconds, and then removed from the molds to obtain a thermoformed sheet.

In an upper convex portion 10 of the thus-thermoformed sheet, the thickness of the formed portion was measured. The thickness of the bottom of the convex portion 10 was from 0.02 to 0.03 mm. The thickness of the area near the boundary between the flat portion and the convex portion 10 of the sheet was from 0.02 to 0.03 mm. Since the bottom and the side were relatively thin in the formed portion in comparison to EXAMPLE 3, the strength of the formed portion was found to be poor in comparison to EXAMPLE 3. When the heating time was reduced to 5 seconds, the softening of the sheet was insufficient to decrease the formability. The thickness of the formed product is shown in TABLE 1. The same nonwoven fabric as used in EXAMPLE 3 was bonded to the surface of the thermoformed sheet which was opposite to the surface on which the convex portions were formed in the same manner as in EXAMPLE 3.

TABLE 1

| | Example 1 | Example 2 | Example 3 | Example 4 |
|---|---|---|---|---|
| Thickness of sheet (mm) | 0.15 | 0.15 | 0.07 | 0.07 |
| Forming method | drape | straight | drape | straight |
| Preheating time (sec) | 13 | 18 | 8 | 10 |
| Forming time*1) (sec) | 1 | 2 | 1 | 2 |
| Cooling time (sec) | 10 | 13 | 7 | 7 |
| Thickness of bottom | 0.11-0.14 | 0.06-0.08 | 0.05-0.06 | 0.02-0.03 |
| (mm) | | | | |
| Thickness of edge (mm) | 0.10-0.12 | 0.06-0.10 | 0.03-0.05 | 0.02-0.03 |

*1) Time for which the molds are raised in the drape-forming, and time for which the molds are contacted to the sheet in the straight-forming.

As shown in TABLE 1, upon comparison of the starting sheets having the same thickness, it is found that the drape-forming could be performed with the preheating time, the forming time and the cooling time which were shorter than those in the straight-forming. The preheating time which is the longest among these times directly influences the overall forming cycle time. However, for example, in EXAMPLE 1, the cycle time can be shortened by approximately 30% in comparison to EXAMPLE 2. Besides, the thickness of the formed portion can also be increased. Thus, the waterproof cover excellent in strength can be obtained.

After the cushioning materials 12, 13 made of the polyurethane foam are packed in the convex portions 10, 11 and the speaker 7 is installed, the waterproof cover 1 obtained in EXAMPLES 1 to 4 is bonded to the inner panel 4 of the automobile door 2 such that the convex portions 10, 11 are directed toward the outside of the automobile and the nonwoven fabric 14 is directed toward the inside of the automobile. At this time, since the area which is approximately 20 mm wide and to which the nonwoven fabric 14 is not bonded is present on the peripheral portion of the waterproof cover 1, the positioning is easy. After the waterproof cover is bonded to the inner panel 4, the door trim 6 is installed. Since the waterproof cover 1 obtained in EXAMPLES 1 to 4 is flexible in comparison to the waterproof cover made only of the linear low-density polyethylene (A), it is possible to prevent occurrence of the vibration sound and also provide the sound absorption effect of the nonwoven fabric 14.

1. A waterproof cover to be interposed between an inner panel and a door trim of an automobile door, the waterproof cover being made of a resin composition comprising a linear low-density polyethylene (A) and an ethylene-propylene copolymer (B).

2. The waterproof cover as claimed in claim 1, wherein an amount of the linear low-density polyethylene (A) is from 50 to 98 parts by weight and an amount of the ethylene-propylene copolymer (B) is from 2 to 50 parts by weight, per 100 parts by weight in total of the linear low-density polyethylene (A) and the ethylene-propylene copolymer (B).

3. The waterproof cover as claimed in claim 1, wherein the resin composition further comprises an inorganic filler (C) in an amount of from 0.1 to 10 parts by weight per 100 parts by weight in total of the linear low-density polyethylene (A) and the ethylene-propylene copolymer (B).

4. The waterproof cover as claimed in claim 1, wherein the resin composition further comprises a lubricant (D) in an amount of from 0.01 to 2 parts by weight per 100 parts by weight in total of the linear low-density polyethylene (A) and the ethylene-propylene copolymer (B).

5. The waterproof cover as claimed in claim 4, wherein the lubricant (D) is a fatty acid amide.

6. The waterproof cover as claimed in claim 1, which is made of a sheet having a convex portion.

7. The waterproof cover as claimed in claim 6, wherein a thickness of the sheet is from 0.05 to 0.5 mm.

8. The waterproof cover as claimed in claim 6, wherein a height of the convex portion is 20 mm or more.

9. The waterproof cover as claimed in claim 6, which is obtained by thermoforming the sheet of the resin composition.

10. A waterproof cover to be interposed between an inner panel and a door trim of an automobile door, in which a melt-blown nonwoven fabric made of a polyolefin fiber is bonded to an inner surface of a sheet being made mainly of a polyolefin.

11. The waterproof cover as claimed in claim 10, wherein the melt-blown nonwoven fabric comprises a polyolefin fiber and a polyester fiber, and a thickness of the fabric as measured under a load of 1.37×10⁻³ N/cm² is from 3 to 30 mm.

12. A process for manufacturing a waterproof cover to be interposed between an inner panel and a door trim of an automobile door, which comprises forming a sheet of a resin composition comprising a linear low-density polyethylene (A) and an ethylene-propylene copolymer (B) to obtain a convex portion.

13. The process for manufacturing the waterproof cover as claimed in claim 12, wherein after forming the sheet, a melt-blown nonwoven fabric made of a polyolefin fiber is laminated, and both of them are partially melt-bonded.

14. A process for manufacturing a waterproof cover to be interposed between an inner panel and a door trim of an automobile door, which comprises thermoforming a sheet made mainly of a polyolefin by drape-forming to obtain a convex portion.

15. The process for manufacturing the waterproof cover as claimed in claim 14, wherein after forming the sheet, a melt-blown nonwoven fabric made of a polyolefin fiber is laminated, and both of them are partially melt-bonded.
